(19) United States
(12) Patent Application Publication
(10) Pub. No.: US 2025/0074698 A1
(43) Pub. Date: Mar. 6, 2025

(54) Critter Proof Bin Lid Lock

(71) Applicants: Johannes Petrus Steenkamp, Shelby Township, MI (US); Cornel Steenkamp, Shelby Township, MI (US)

(72) Inventors: Johannes Petrus Steenkamp, Shelby Township, MI (US); Cornel Steenkamp, Shelby Township, MI (US)

(21) Appl. No.: 18/458,952

(22) Filed: Aug. 30, 2023

(51) Int. Cl. B65F 1/16; E05B 15/00

(52) U.S. Cl. CPC B65F 1/1615; B65F 1/1646; E05B 15/0093; B65F 2210/148

(57) ABSTRACT

Critter Proof Bin Lid Lock, for Litter Prevention and Environmental Safety. Discourage critters like Raccoons, Possums, Squirrels, Birds and various other animals even Monkeys and Baboons from scavenging for human food and endangering themselves well as wind blowing lids open but still automatically releases during waste collecting process.

### RELATED APPLICATIONS

There are no related applications other than the provisional patent submitted Sep. 19, 2022. Application 63/376,261.

### ORIGIN OF THE INVENTION

The need to prevent littering and general concern for the environment by eliminating the concern of waste management in our streets an suburbs, humans have invaded most habitats and thus animals natural curiosity and need for food will lead them to our water bins this invention is to save environment against waste animals from humans waste from households than can be harmful and dangerous to them. The Critter Proof Bin Lid Lock prevents access to the contents of each Bin being reached by Animals or Elements like Wind in normal upright position.

### BACKGROUND OF THE INVENTION

Homeowners, businesses, communities, Gated communities, Shop owners, and even Cities councils use what is commonly known as “Wheelie type Garbage bins, Trash Cans, Wastebins” to place refuse in, before such refuse is collected and removed to dumping sites by various removal companies. These bins often contain refuse and waste that attract all types of Critters like Raccoons, Opossums Squirrels, neighborhood Dogs, Armadillos, Bears and even Birds like Ravens and in other countries Monkeys and Baboons and yes even Cockatoos have been seen opening household garbage bins, and they create a mess by taking refuse out the bins causing littering and even dangerous situations that can cause injuries to the animals. themselves. In addition, strong wind gusts has been known to blow open Bin lids and spread the garbage all over as well. The most bins do not have closing mechanisms that will prevent these critters from opening the lids. Some people place bungy cords Door type locks even rocks or bricks on the lids or tie them down with rope or other elastic cords. These methods are all short term solutions as the companies that collect the waste have to remove, de-latch these lock closing methods sometimes ineffective prevention methods casing a huge problems on both ends of the spectrum, the owner of the trash bin trying to prevent animals from getting into the waste and waste collectors having to spend half their time opening bins or struggling to open all kinds of locking methods that does not support the them in the Job at hand. Imagine the amount of time a person needs to spend in the Subzero temperature due to locking methods that does not support the automated machinery used if it was me I would not even remove people waste that does not consider the person having to spend time in the elements opening waste lids.

### BRIEF STATEMENT OF THE INVENTION

Prevention of Trash/Refuse Bin lids from being opened by Animals or Elements like Wind in normal upright position. The Critter proof Bin Lid Lock is always in a locked position by design when the lid is closed, and the lock pin will keep the lid from being opened.

### SUMMARY OF THE INVENTION

The Critter Proof Bin Lid Lock acts as a locking device prevent access to the contents of Trash/Refuse Bins, by Animals or Elements like Wind in normal upright position rash/Refuse Bin lids Trash Bin lids are easily opened exposing the contents to Animals or Elements like Wind in normal upright position. The Critter proof Bin Lid Lock is always in a locked position by design when the lid is closed, and the lock pin will keep the lid from being opened.

### TECHNICAL FIELD OF THE INVENTION

The Critter proof Bin Lid Lock attaches or can be built in as an integral part of a lid, a mechanism that will prevent the Trash Bin lids from being opened by Animals or Elements like Wind in normal upright position. The Bin Lid Lock is always in a locked position by design when the lid is closed, and the lock latch will keep the lid from being opened by most animals and even elements like wind.

### BRIEF DESCRIPTION OF DRAWINGS

FIG. 1 Show all components attached and in position. The Critter proof Bin Lid lock has seven different types of components with 3 are unique in design and are manufactured to the design specifications in this application the Screws, U Clip and Loack Nut are standard metric size components sourced from local suppliers for manufacturing process. The assembled part becomes the functioning part. FIG. 2 through 9 are the individual components and function. FIGS. 10 to 12 are installed illustrations.

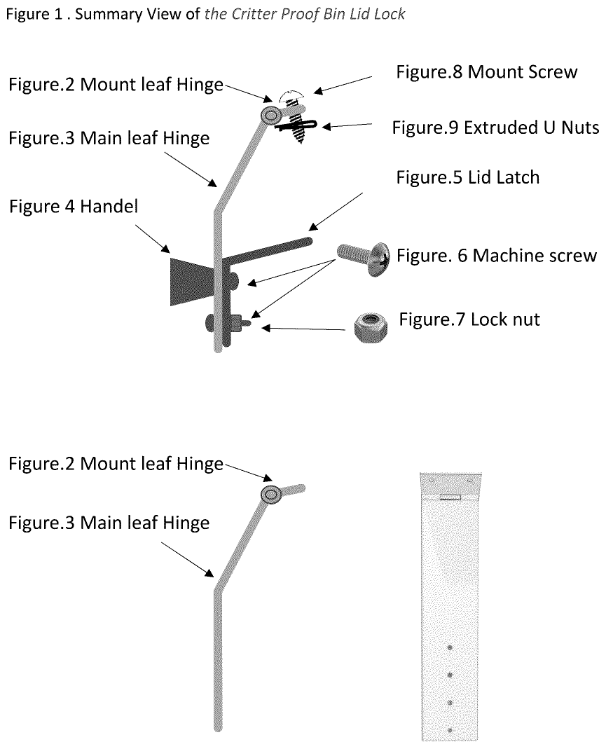

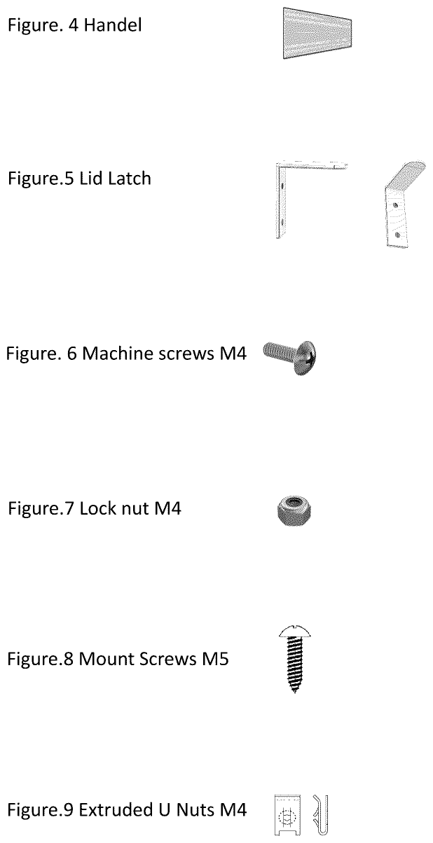

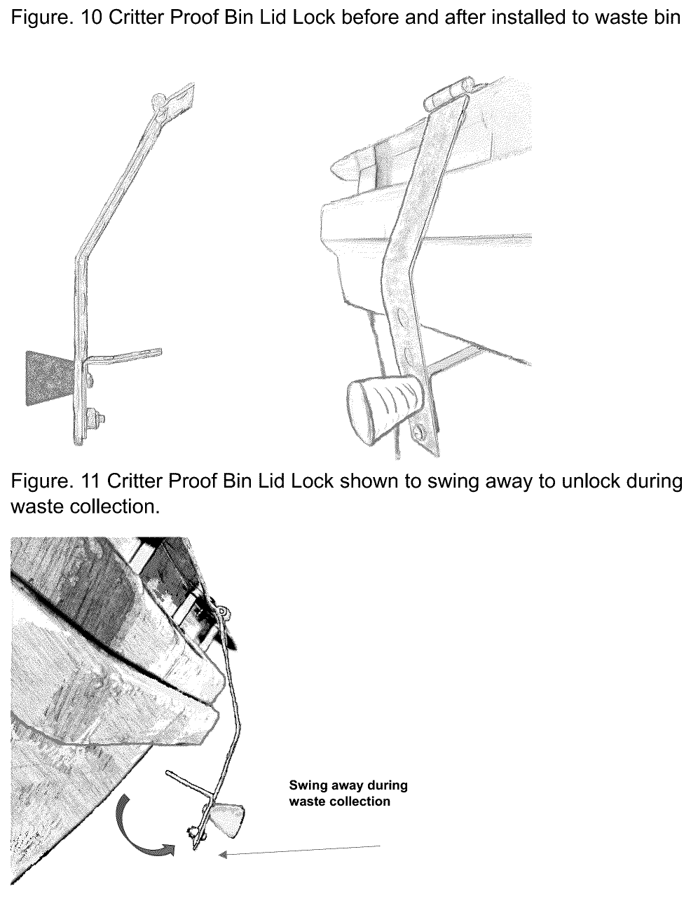

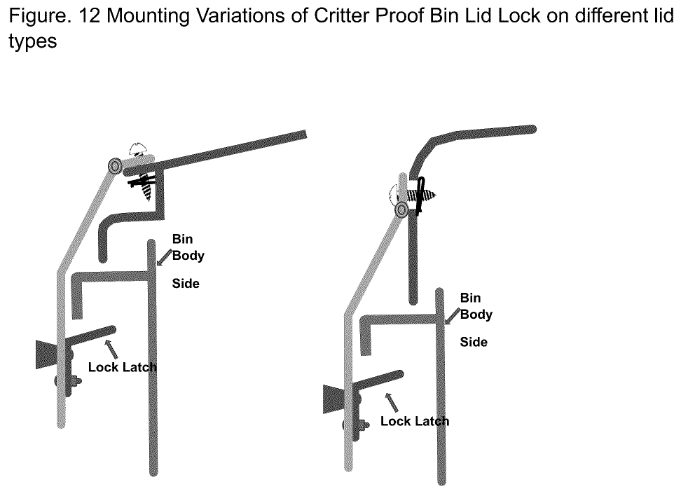

### BRIEF DESCRIPTION OF FIGURES

FIGS. 2 and 3 is a perspective view of the main body of The Critter Proof Bin Lid Lock, all components mount to the main body, the main body also mounts to the waste bin lid. FIGS. 2 and 3 is also in joined by a hinge point.

FIG. 4 is a perspective view of the Handel that serves as the mechanism by which The Critter Proof Bin Lid Lock is gripped to lift the waste bin lid to place waste into the bin.

FIG. 5 is a perspective view of the Lid Latch that serves as the locking point by latching onto the waster bin features to serve as the lock of The Critter Proof Bin Lid Lock.

FIG. 6 is a perspective view of the mount screws that serves as the mount device to the Handel and Latch.

FIG. 7 is a perspective view of the lock nut that holds one of the screws in place that keeps the latch mounted to the main body.

FIG. 8 is a perspective view of the Lid Latch mount screws that mount the main body to the waste bin.

FIG. 9 is a perspective view of the Lid Latch U Clips that locks the screws in place the same way as a lock nut.

### DESCRIPTION OF THE INVENTION

The Critter Proof Bin Lid Lock attaches or can be built in as an integral part of a lid, a mechanism that will prevent the Trash Bin lids from being opened by Animals or Elements like Wind in normal upright position. The Bin Lid Lock is always in a locked position by design when the lid is closed, and the lock pin will keep the lid from being opened by most animals and even elements like wind. The Critter Proof Bin Lid Lock may not prevent Bears from opening a Bin lid due to the brute strength or when the bin is toppled over, in the decanting direction of waste collection. The design uses natural gravity as the support to keep the Critter Proof Bin Lid Lock closed at all times but also supports the automated mechanical decanting process of most waste removal trucks or containers. The lid can be opened by holding the latch clear from the bins side latch lip and lifting the lid as you normally would when opening the Bin. The idea is not to create an obstructed operation but will be easy to operate for any intelligent being above the intelligence of an animal or bird or natural elements like wind.

Such a mechanism is constructed or made by metal shaped to conform to the curved form of the various shapes and forms of Wheelie bins or trach bins. The suitable material will have a level of rust inhibitor such as galvanizing, stainless steel or even rust preventative coating. Or paint. The Critter Proof Bin Lid Lock will be mounted to the lid top side or edge with suitable fixations such as screws or bolts or clip to the front or side of the lid of the bin, it will be hinged as an integral part of the lid. This Critter Proof Bin Lid Lock will hang down and have a latch lip that can be positioned to suit various bins shapes. This latch pin will hook under a molded feature or added feature of the Bin that will prevent the lid from being opened. The mechanism will be shaped to provide a grip to enable a person to disengage The Critter Proof Bin Lid Lock by a single hand.

Some of the material, but not restricted to that, may be painted, galvanized or plated bent into the correct shape and bolted or screwed onto the lid or it could be made out of the same plastic that the bin is made of or even Coated by rubber, formed into the correct shape and bolted or otherwise attached to the lid or formed as part of the lid. The mechanism may also be made of spring steel or any other suitable material and attached or formed in any suitable manner.

1. We claim That the Critter Proof Bin Lid Lock will automatically unlock the lid during the waste collection prosses when performed by an unobstructed automated mechanical waste removal trucks or containers, enabling waste to be emptied without interference from the Critter Proof Bin Lid Lock.

2. We claim That the Critter Proof Bin Lid Lock will stop a waste bin lid from being opened with normal force when the waste bin is in an upright position, Not intended to stop Bears.

3. We claim That the Critter Proof Bin Lid Lock consists of plural metal ends hinged together to form the body of the main part.
